(19) United States
(12) Patent Application Publication
(10) Pub. No.: US 2026/0343073 A1
(43) Pub. Date: Oct. 29, 2026

(54) Systems and Methods for Processing Video Elements

(71) Applicant: Canva Pty Ltd, Surry Hills (AU)

(72) Inventor: Phillip HAEUSLER, Melbourne (AU)

(73) Assignee: Canva Pty Ltd, Surry Hills (AU)

(21) Appl. No.: 19/187,914

(22) Filed: Apr. 23, 2025

(51) Int. Cl. H04N 21/8549; G11B 27/031

(52) U.S. Cl. CPC H04N 21/8549; G11B 27/031

(57) ABSTRACT

Described herein is a computer implemented method for generating one or more chapter clips for a video content item, the method includes: receiving a request to generate the one or more chapter clips, the request including the video content item; generating an audio transcript from an audio component of the video content item; generating one or more key frames from a video component of the video content item; identifying one or more chapters in the video content item based on the audio transcript and the one or more frames, each chapter comprising a start time and an end time; generating the one or more chapter clips based on the identified one or more chapters based on the start time and the end time of each chapter; and causing display of the one or more chapter clips in a user interface displayed on a user device.

### TECHNICAL FIELD

Aspects of the present disclosure are generally related to video content items and more particularly to systems and methods for processing video content items.

### BACKGROUND

Various computer applications for processing and editing multimedia content items, such as video clips exist. Such applications allow users to create and/or edit existing video content items.

A common processing task provided by such computer applications in video editing is view an entire content item and identify relevant content in the video content item. Users typically use these relevant portions of videos to create further content such as social media reels, short videos, etc. Typically, to identify relevant moments in a video, a user often has to watch and re-watch a video content item many times to identify the content in the video and then manually edit the video.

### SUMMARY

Described herein is a computer implemented method for generating one or more chapter clips for a video content item, the method includes: receiving a request to generate the one or more chapter clips, the request including the video content item; generating an audio transcript from an audio component of the video content item; generating one or more key frames from a video component of the video content item; identifying one or more chapters in the video content item based on the audio transcript and the one or more frames, each chapter comprising a start time and an end time; generating the one or more chapter clips based on the identified one or more chapters based on the start time and the end time of each chapter; and causing display of the one or more chapter clips in a user interface displayed on a user device.

Also described herein is a computer processing system including: a processing unit; and a non-transitory computer-readable storage medium storing instructions, which when executed by the processing unit, cause the processing unit to perform the method described above.

Further described herein is a non-transitory storage medium storing instructions executable by a processing unit to cause the processing unit to perform the method described above.

### BRIEF DESCRIPTION OF THE DRAWINGS

In the drawings:

FIG. 1 is a block diagram depicting a networked environment in which various features of the present disclosure may be implemented.

FIG. 2 is a block diagram of a computer processing system configurable to perform various features of the present disclosure.

FIG. 3 is a block diagram depicting a chapter generation system configured to perform various features of the present disclosure.

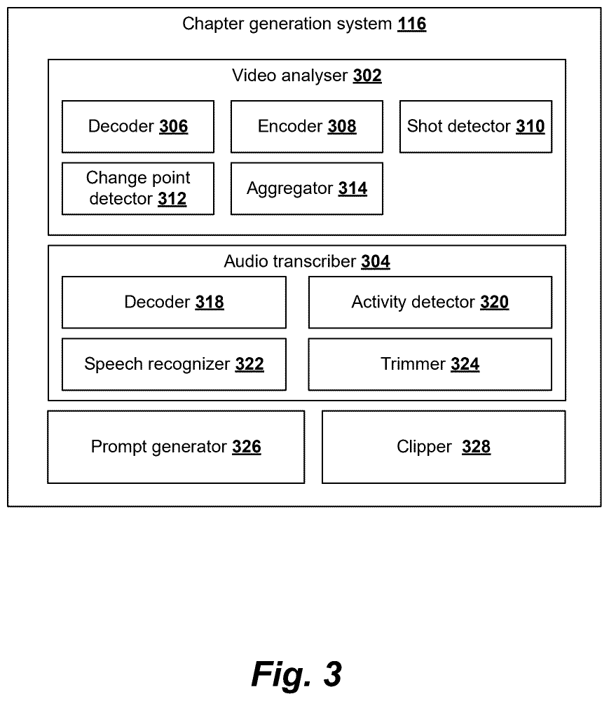

FIG. 4 is an example user interface according to aspects of the present disclosure.

FIG. 5 is a flowchart illustrating an example method for automatically identifying chapters in a video content item according to some aspects of the present disclosure.

FIG. 6 is a flowchart illustrating an example method for generating a transcript of audio according to aspects of the present disclosure.

FIG. 7 is a flowchart illustrating an example method for generating captions for one or more frames of video content according to aspects of the present disclosure.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth to provide a thorough understanding of the present invention. It will be apparent, however, that the present invention may be practiced without these specific details. In some instances, well-known structures and devices are shown in block diagram form to avoid unnecessary obscuring.

As described previously, during video editing, users often re-watch their content many times to identify the content of a video clip and to find relevant moments in a video content item to use in various downstream applications such as designs, posts, reels, shorts, etc. Generally, the relevant moments in a video can include interesting content, narratively significant content, visually appealing content, etc.

Once users have identified any useful, interesting, or narratively important content, users have to usually manually select the start and end timings of such content and trim the video to the identified relevant content. This can be achieved by dragging markers on a video timeline to set precise points. Once the beginning and end of the relevant content is identified, the user may utilize the editing application to delete the remainder of the video footage, leaving only the desired segments.

It will be appreciated that this process can be challenging and time consuming-especially when numerous video content items have to be analyzed. For example, accurately identifying the start and end times of multiple relevant moments in a video content item can be difficult. Further, users may need to review the relevant moments numerous times to ensure smooth transitions and proper pacing. They may involve further adjustments by repositioning the start and end timings in the video clip.

Aspects of the present disclosure are directed to systems and methods for automatically analyzing video content and identifying one or more chapters in the video content having start and end timings. The identified chapters can then be displayed in the video editing application. For example, in an upload interface that allows a user to select one or more chapters from the video clip to upload and/or in a timeline interface that allows a user to view and/or trim to one or more chapters in the video clip.

To do so, aspects of the present disclosure employ a chapter generation system that analyses video content items, identifies chapters within the content items, and automatically generates titles of the identified chapters.

These and other aspects of the present disclosure will now be described in detail with reference to the following figures.

### Network Architecture and System

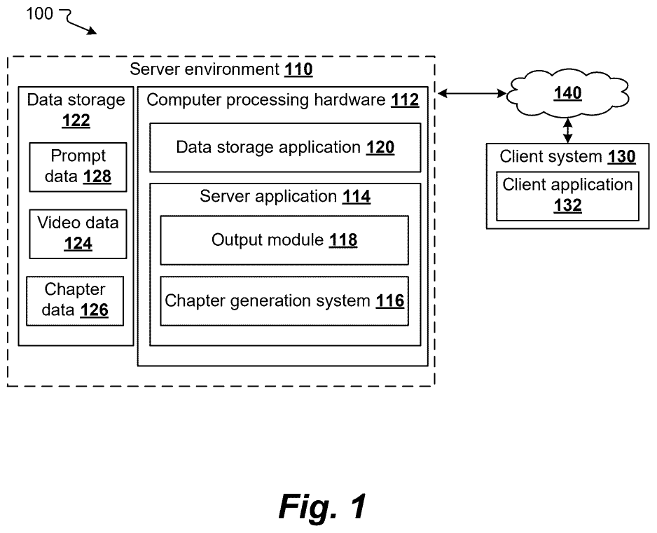

FIG. 1 is a block diagram depicting a networked environment 100 in which various features of the present disclosure may be implemented. The environment 100 includes server- and client-side applications, which operate together to perform the processing described herein. In particular, it includes a video editing server 110 and a client system 130, which communicate via one or more communications networks 140 (e.g., the Internet).

The video editing server 110 includes computer processing hardware 112 (discussed below) on which applications that provide server-side functionality to client applications such as client application 132 (described below) execute. In the present example, the video editing server 110 includes a server application 114 and a data storage application 120.

The server application 114 may execute to provide a client application endpoint that is accessible over the communications network 150. For example, where the server application 114 serves web browser client applications, the server application 114 will be hosted by a web server which receives and responds (for example) to HTTP requests. Where the server application 114 serves native client applications, the server application 114 may be hosted by an application server configured to receive, process, and respond to specifically defined API calls received from those client applications. The video editing server 110 may include one or more web server applications and/or one or more application server applications allowing it to interact with both web and native client applications.

The server application 114 facilitates various functions related to editing video content items in the video editing server 110. This may include, for example, uploading, viewing, editing, storing, trimming, and/or retrieving video content items. The server application 114 may also facilitate additional functions that are typical of server systems—for example user account creation and management, user authentication, and/or other server-side functions. Each of these functionalities may be provided by individual applications, e.g., an account management application (not shown) for account creation and management, a video creation application (not shown) to aid users in creating, editing, storing video content items, a management application (not shown) that is configured to maintain and store video content items and trimmed video clips in the data storage, etc.

In addition to these functions, the server application 114 is also configured to analyze video content items and identify one or more chapters in the video content item. To do so, the server application 114 includes a chapter generation system 116 and an output module 118. The chapter generation system 116 is configured to receive video content items and automatically generate one or more chapters from the video content items.

The output module 118 is configured to receive the chapters from the chapter generation system 116 and render chapter video clips for display on one or more display devices of client system 130. Operations of these subsystems will be described in more detail later.

Although the chapter generation system 116 is depicted as part of the video editing server 110, in some embodiments, this may be an independent application hosted by one or more different server systems.

The data storage application 120 executes to receive and process requests to persistently store and retrieve data relevant to the operations performed/services provided by the server application 114, and/or the chapter generation system 116. Such requests may be received from the server application 114, and/or the chapter generation system 116, and/or (in some instances) directly from client applications such as 132.

The data storage application 120 may, for example, be a relational database management application or an alternative application for storing and retrieving data from data storage 122. Data storage 122 may be any appropriate data storage device (or set of devices), for example one or more non-transitory computer readable storage devices such as hard disks, solid state drives, tape drives, or alternative computer readable storage devices.

In video editing server 110, the server application 114 persistently stores data to data storage 122 via the data storage application 120. In alternative implementations, however, the server application 114 may be configured to directly interact with data storage devices such as 122 to store and retrieve data (in which case a separate data storage application 120 may not be needed). Furthermore, while a single data storage application 120 is described, the video editing server 110 may include multiple data storage applications.

The data storage 122 maintains data relevant to the operations performed/services provided by the server application 114 and/or the chapter generation system 116. In some embodiments, the data storage 122 includes video data 124 for a set of video content items made available by the video editing server 110 or saved by users at the video editing server 110. The data storage further stores chapter data 126 of the chapter clips generated by the server application 114. The chapter data for each chapter clip may include trim parameters such as the start time, end time and/or duration of the chapter and which video content item it is related to. Further still, the data storage 122 may store prompt data 128 that may be used by the chapter generation system 116 to automatically identify chapters. Some of the data stored by the data storage 122 will be described in detail in the following sections.

Although a single data storage 122 is displayed in FIG. 1, it will be appreciated that the data storage 122 may include multiple individual data stores for storing different types of data. For example, one data store may be used for user account data, another for design data, another for design asset data, another for chapter data, and so forth.

As noted, the server application 114 and/or the chapter generation system 116 run on (or are executed by) computer processing hardware 112. Computer processing hardware 112 includes one or more computer processing systems. The precise number and nature of those systems will depend on the architecture of the video editing server 110.

For example, in one implementation multiple instances of the server application 114 and/or the chapter generation system 116 may run on their own dedicated computer processing systems. In another implementation, two or more instances of the server applications 114 and/or the chapter generation system 116 may run on a common/shared computer processing system. In a further implementation, video editing server 110 is scalable in which application instances (and the computer processing hardware 112—i.e. the specific computer processing systems required to run those instances) are commissioned and decommissioned according to demand—e.g., in a public or private cloud-type system. In this case, video editing server 110 may simultaneously run multiple instances of each application 114 (on one or multiple computer processing systems) as required by client demand. Where the video editing server 110 is a scalable system, it will include additional applications to those illustrated and described. As one example, the video editing server 110 may include a load balancing application (not shown) which operates to determine demand, direct client traffic to the appropriate application instance (where multiple applications have been commissioned), trigger the commissioning of additional applications (and/or computer processing systems to run those applications) if required to meet the current demand, and/or trigger the decommissioning of server applications (and computer processing systems) if they are not functioning correctly and/or are not required for current demand.

Communication between the applications and computer processing systems of the video editing server 110 may be by any appropriate means, for example direct communication or networked communication over one or more local area networks, wide area networks, and/or public networks (with a secure logical overlay, such as a VPN, if required).

The present disclosure describes various operations that are performed by applications of the video editing server 110. However, operations described as being performed by a particular application (e.g., output module 118) could be performed by one or more alternative applications, and/or operations described as being performed by multiple separate applications could in some instances be performed by a single application.

Client system 130 hosts a client application 132 which, when executed by the client system 130, configures the client system 130 to provide client-side functionality/interact with the video editing server 110. Via the client application 132, and as discussed in detail below, a user can access the various techniques described herein—e.g., the user can upload or select video content items, view and/or preview video content items, request chapters of a video content item, review one or more chapters automatically generated by the system, edit, or publish one or more chapters, etc. Client application 132 may also provide a user with access to additional editing related operations, such as creating, editing, playing, saving, publishing, sharing, and/or other video related operations.

The client application 132 may be a general web browser application which accesses the server application 114 and/or the data storage application 120 via an appropriate uniform resource locator (URL) and communicates with these server applications via general world-wide-web protocols (e.g. HTTP, HTTPS, FTP). Alternatively, the client application 132 may be a native application programmed to communicate with the server application 114 and/or the data storage application 120 using defined application programming interface (API) calls and responses.

A given client system such as 130 may have more than one client application 132 installed and executing thereon. For example, a client system 130 may have a (or multiple) general web browser application(s) and a native client application.

The present disclosure describes some method steps and/or processing as being performed by the client application 132. In certain embodiments, the functionality described may be natively provided by the client application 132 (e.g. the client application 132 itself has instructions and data which, when executed, cause the client application 132 to perform the described steps or functions). In alternative embodiments, the functionality described herein may be provided by a separate software module (such as an add-on or plug-in) that operates in conjunction with the client application 132 to expand the functionality thereof.

While the embodiments described below make use of a client-server architecture, the techniques and processing described herein could be adapted to be executed in a stand-alone context—e.g. by an application (or set of applications) that run on a computer processing system and can perform all required functionality without need of a server environment or application.

The techniques and operations described herein are performed by one or more computer processing systems.

By way of example, client system 130 may be any computer processing system which is configured (or configurable) by hardware and/or software—e.g. client application 132—to offer client-side functionality. A client system 130 may be a desktop computer, laptop computer, tablet computing device, mobile/smart phone, or other appropriate computer processing system.

Similarly, the applications of the video editing server 110 are also executed by one or more computer processing systems (the computer processing hardware 112). Server computer processing systems will typically be server systems, though again may be any appropriate computer processing systems.

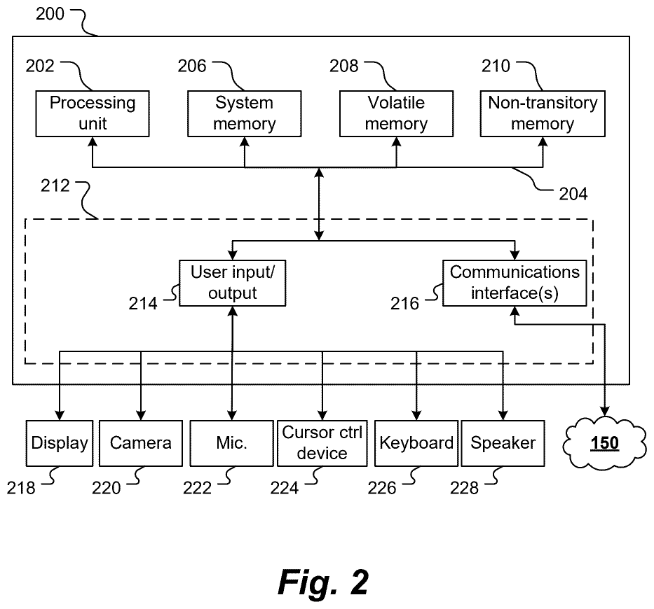

FIG. 2 provides a block diagram of a computer processing system 200 configurable to implement embodiments and/or features described herein. System 200 is a general-purpose computer processing system. It will be appreciated that FIG. 2 does not illustrate all functional or physical components of a computer processing system. For example, no power supply or power supply interface has been depicted, however system 200 either carries a power supply or is configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable (either in a shared or dedicated manner) by system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random-access memory such as one or more DRAM modules), and non-transitory memory 210 (e.g. one or more hard disk or solid-state drives).

System 200 also includes one or more interfaces, indicated generally by 212, via which system 200 interfaces with various devices and/or networks. Other devices may be integral with system 200 or may be separate. Where a device is separate from system 200, the connection between the device and system 200 may be via wired or wireless hardware and communication protocols and may be a direct or an indirect (e.g. networked) connection.

Generally speaking, and depending on the system in question, devices to which system 200 connects include one or more input devices to allow data to be input into/received by system 200 and one or more output device to allow data to be output by system 200.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228.

As another example, where system 200 is a portable personal computing device such as a smart phone or tablet it may include a touchscreen display 218, a camera device 220, a microphone device 222, and a speaker device 228.

Where client application 132 operates to display controls, interfaces, or other objects, client application 132 does so via one or more displays that are connected to (or integral with) system 200—e.g. display 218. Where client application 132 operates to receive or detect user input, such input is provided via one or more input devices that are connected to (or integral with) system 200—e.g. touch screen, touch screen display 218, cursor control device 224, keyboard 226, and/or an alternative input device.

As another example, where system 200 is a server computing device it may be remotely operable from another computing device via a communication network (e.g., network 140). Such a server may not itself need/require further peripherals such as a display, keyboard, cursor control device etc. (though may nonetheless be connectable to such devices via appropriate ports).

Alternative types of computer processing systems, with additional/alternative input and output devices, are possible.

System 200 also includes one or more communications interfaces 216 for communication with a network, such as network 140 of environment 100 (and/or a local network within the video editing server 110). Via the communications interface(s) 216, system 200 can communicate data to and receive data from networked systems and/or devices.

System 200 stores or has access to computer applications (which may also be referred to as computer software or computer programs). Such applications include computer readable instructions and data which, when executed by the processing unit 202, configure system 200 to receive, process, and output data. Instructions and data can be stored on non-transitory machine-readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example and referring to the networked environment of FIG. 1 above, video editing server 110 includes one or more systems which run a server application 114, a data storage application 120, and/or the chapter generation system 116. Similarly, client system 130 runs a client application 132.

In some cases, part or all of a given computer-implemented method will be performed by system 200 itself, while in other cases processing may be performed by other devices in data communication with system 200.

### Chapter Generation System

As described previously, the chapter generation system 116 is configured to analyze video content items and automatically generate one or more chapter clips from these video content items. To do so, it includes a video analyzer 302 that is configured to analyze a video component of the video content items and identify one or more key frames in the video, and an audio transcriber 304 that is configured to analyze an audio component of the video content item and generate text for any speech identified in the audio component.

To analyze the video, the video analyzer 302 further includes a video decoder 306 that is configured to identify individual frames in the video content items, and an encoder 308 that is configured to convert each video frame into a vector embedding. The video analyzer 302 further includes a shot detector 310 that is configured to identify shot boundaries in the video content item. Each shot is a continuous sequence of frames taken by a camera. Edited videos are usually composed of multiple shots stitched together. Identifying individual shots in the video content item helps the video analyzer 302 understand how a video content item is changing.

The video analyzer 302 further includes a change point detector 312 and an aggregator 314. The change point detector 312 is configured to identify a minimum set of key frames in the video content item where sufficient change has occurred. This allows the video analyzer 302 to minimize the number of frames which are finally provided to a clipper 328. The aggregator 314 combines the shots and the change point frames to generate a set of shots and their corresponding change point frames.

To generate text for any speech identified in the audio component, the audio transcriber 304 includes a decoder 318, an activity detector 320, a speech recognizer 322 and a trimmer 324. The decoder 318 converts the audio component of the video content item into a format that can be further processed by the audio transcriber 304. This may include normalizing, sampling, and decoding the audio file. The activity detector 320 identifies any speech in an audio file. The trimmer 324 trims the audio file to segments where speech is detected and the speech recognizer 322 predicts the words spoken in the trimmed speech segments of the audio component.

The chapter generation system 116 further includes a prompt generator 326 that receives the video component and the transcribed audio component from the video analyzer 302 and the audio transcriber 304, respectively, and generates a timestamped script based on both these pieces of data. The timestamped script includes any dialogs in the video content item with their timestamps and the video key frames with their corresponding timestamps.

The chapter generation system 116 further includes a clipper 328 that is configured to analyze the timestamped script and identify start and end times for one or more chapter clips in the video content item.

Operation of these components will be described in detail later.

### User Interface

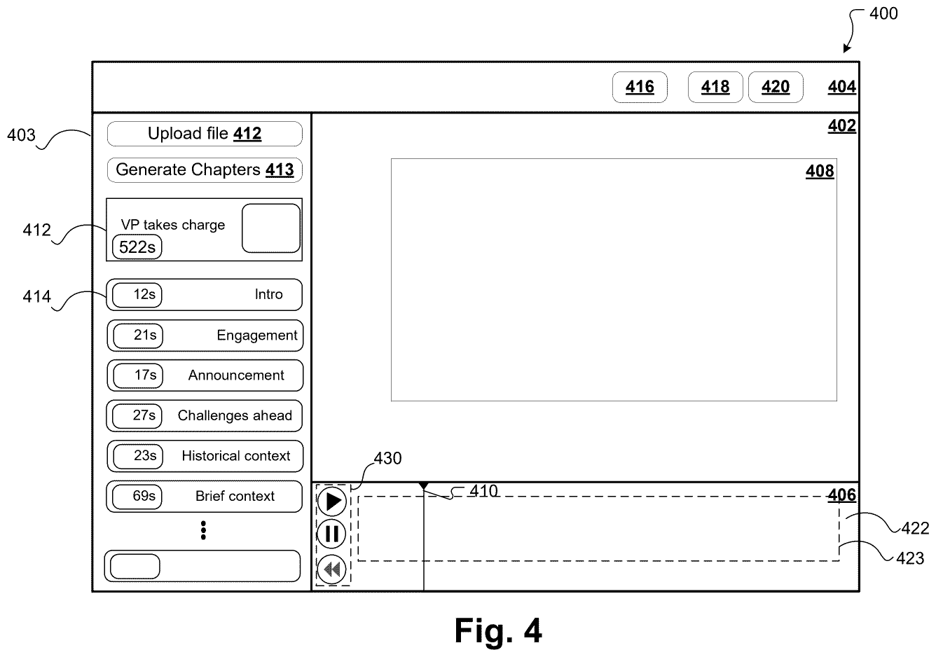

In the present disclosure, the client application 132 configures the client system 130 to provide an editor user interface (UI). Generally speaking, the editor UI allows a user to preview, view, create, edit, and output video content items. FIG. 4 provides a simplified and partial example of an editor UI 400. In this example, the UI 400 is a graphical user interface (GUI).

UI 400 includes a preview region 402, an upload region 403, a control region 404, and a timeline region 406.

The preview region 402 displays a still 408 from a video content item that corresponds to a particular position (time) in the video content item. The particular time that the still 408 corresponds to is indicated by a playhead 410, which is displayed in the timeline region 406.

The upload region 403 includes two controls—an upload file control 412 and a generate chapters control 413. The upload file control when selected allows a user to upload one or more video content items to the video editing server 110. Once a user has uploaded one or more video content items, the generate chapters control 413 may be activated. Selection of this control causes the chapter generate system 116 to automatically generate one or more chapter clips from the uploaded video content item using methods 500-700.

In some embodiments, the upload region 403 displays a selectable affordance 412 for the full video content item, “VP takes charge” in this example. The selectable affordance 412 displays a frame from the video content item, a title of the video content item, and a duration of the video content item. Selection of the selectable affordance 412 causes the video content item to be displayed in the preview region 402.

Once the generate chapters control 413 is selected, the upload region 403 also displays selectable affordances 420 for each of the chapter clips generated from the video content item. Each chapter clip may also include a chapter title and chapter duration. In addition, in some embodiments, the selectable chapter clip affordance 420 may further include a video frame (not shown) associated with the chapter clip. Selection of a selectable affordance 414 causes the corresponding chapter clip to be displayed in the preview region 402.

The control region 404 includes controls that allow a user to edit and/or adjust characteristics of the video content item. In the example illustrated in FIG. 4, the control region 404 includes three controls 416-420 (though may have additional or fewer additional controls). Control 416 is an upload control, which when selected causes the server application 114 and/or the chapter generation system 116 to display the upload region 407.

Some controls may be permanently displayed in the control region 404. For example, control 418 may be a permanently displayed ‘publish’ control, which a user can activate to publish, share, or save the video content item currently being worked on. When the video content item is saved, a new video content item record can be generated and saved in the data storage 122. As another example, a particular control (e.g., 420) may be a toggle control allowing a user to display or hide the timeline region.

The timeline region 406 is used to display a video timeline 422. The video timeline 422 includes scene previews (not shown) that correspond to scenes of the video content item.

In the present example, the timeline region 406 also includes controls 430 to engage with the video content item such as a play control, a pause control, or a rewind control. Activation of the play control causes the video content item to play from the position (time) indicated by the playhead 410 (e.g. in preview region 402). The pause control when activated causes the video content item to pause playback. Similarly, the rewind control when activated causes the video content item to move backwards in time. When the video content item is playing, a progress indicator is displayed in the timeline region 406 indicating the current play position of the video content item. The progress indicator may be playhead 410. A user may be able to interact with the playhead 410 (via the client application 132 on client system 130) to move the playhead 410 and, therefore, playback of the video content item to a particular time.

Alternative interfaces, with alternative layouts and/or alternative tools and functions, are possible. For example, the editor GUI 400 typically include many other controls that permit designs to be created, edited (by creating/adding design elements such as images, text, videos, and/or other elements), and output (e.g. saving to local memory, a data store such a 122, printing, publishing via social media, and/or other means) in various ways.

It will be appreciated that in UI 400, selection of the various user input controls can be done in various ways. For example, a user may select the one or more interactive controls using a keyboard or mouse. Alternatively, a user may select an interactive control by speaking. In such cases, words are captured by a microphone (e.g., microphone 222) and converted to text using appropriate speech-to-text software and then used to select the one or more interactive controls.

### Example Methods

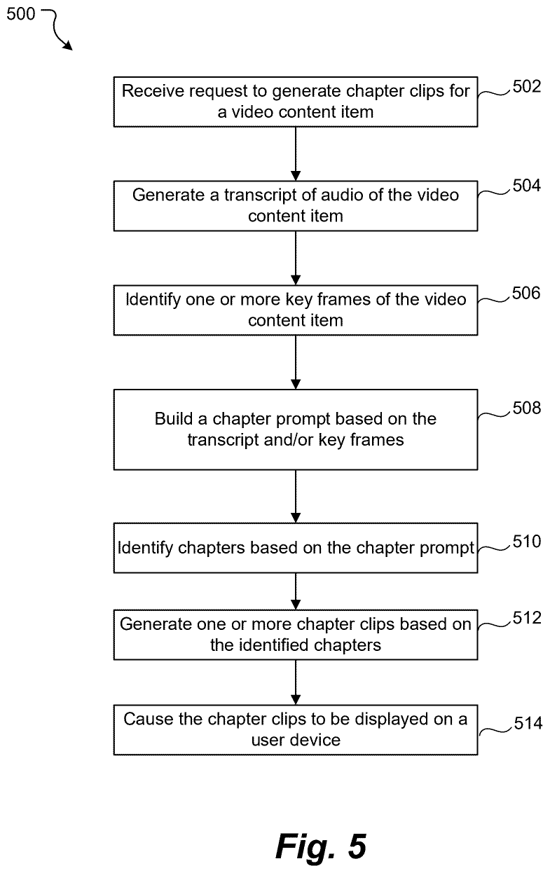

FIG. 5 illustrates an example method for automatically generating chapter clips from a video content item. The method is described with reference to a single video content item. However, it will be appreciated that this method can be performed multiple times for multiple video content items.

The operations of this method will generally be described as being performed by the client application 132, the server application 114, and the chapter generation system 116. The operations could, however, be performed by one or more alternative applications running on the video editing server 110 and/or one or more alternative computer processing systems.

The server application 114 may be configured to perform method 500 in response to detecting one or more trigger events. As one example, the server application 114 may communicate with application 132 (e.g. via network 140) to cause application 132 to display a user interface, e.g., user interface 400 displayed in FIG. 4. A user may add or otherwise upload a video using the upload file control 412 and may be previewing/editing the video via the user interface 400.

In some embodiments, the method 500 may commence when a user activates the generate chapters control 413.

At step 502, a request for generating chapters is received at the server application 114. In one example, once the user activates the control 413, the client application 132 creates a request for chapter clips to be generated for the uploaded video content item and passes the video content item along with the request to the server application 114.

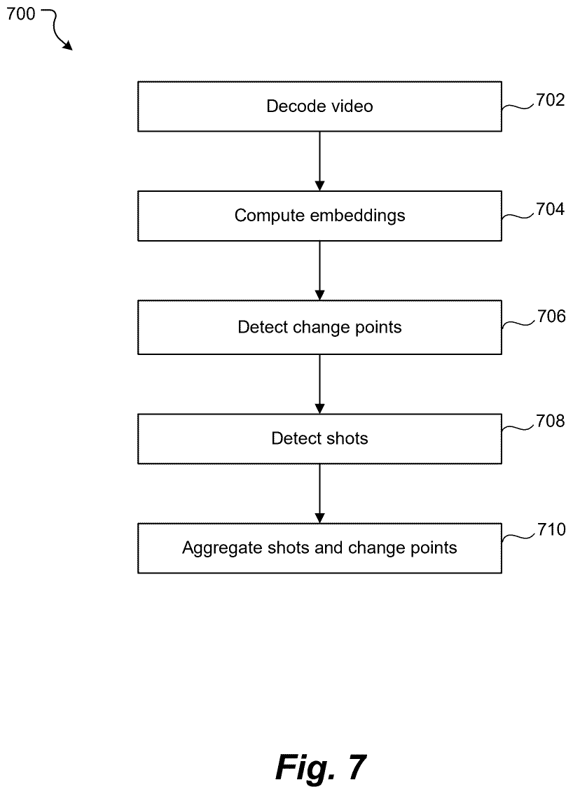

At step 504, the audio transcriber 304 generates a transcript of an audio component of the video content item. The transcript includes any words spoken in the video content item along with an estimated timing of the words. The method for generating the audio transcript is described in detail with reference to FIG. 7. An example of the audio transcript generated at this step for a cooking video is provided in table A below—

TABLE A
example audio transcript

2.7-4.0: Hello,
4.0-8.6: My name is ABC and I'm inside the kitchen XYZ Pizza
8.6-11.2: restaurant in Malaysia.
11.2-13.5: we have a few outlets open,
13.5-15.1: XYZ Pizza. And,
15.1-19.5: honor by ABC's family.
19.5-23.6: so, today I'm going to show you spaghetti aglio e olio and chili.

At step 506, the video analyzer 302 generates one or more key frames of the video content. The method for generating the one or more key frames is described in detail with reference to FIG. 7.

At step 508, a chapter prompt is generated. In one embodiment, the prompt generator 326 generates the chapter prompt based on the transcript and the one or more key frames. The dialogs from the audio transcript are timestamped and so are the one or more key frames. The chapter prompt includes these timestamped dialogs and the timestamped key frames.

The exact content of the chapter prompt will depend on the type of clipper 328 being used. If the clipper 328 is a general purpose vision language model (VLM), the chapter prompt includes the video script, the one or more key frames, and configuration data, which provides instructions to the clipper 328 to identify the chapters based on the audio transcript and the one or more key frames. In case the clipper 328 includes a specific VLM that has already been trained for the specific task of identifying chapters from audio scripts and key frames, the chapter prompt may only include the audio script and the key frames.

The precise format of the configuration data depends on a variety of factors, including the type of VLM (e.g., configuration data for use with OpenAI's GPT4o may differ from the configuration data required for Gemini® or Claude®), the training mechanism of the clipper 328, and the content of the audio script/key frames (and/or other available data).

In one example, the configuration data for the chapter prompt may include a brief description of the task (e.g., to determine the start and end time of chapters in a video clip), parameters for the task (e.g., output format, rules, etc.), and one or more training examples of inputs and the desired outputs the clipper 328 is expected to generate based on those inputs. Table B below shows examples of configuration data that can be used.

TABLE B
example configuration data for a chapter prompt

| | |
|---|---|
| Description | Identify chapters in the video clip based on the provided |
| of task: | SCRIPT and KEY FRAMES. Each chapter should |
| | have a start time and an end time and be associated |
| | with a distinct theme. |
| Parameters: | Chapters must not overlap |
| | Longer chapters are preferred |
| | Consider the dialog and the visual impact of the key frames. |
| | Titles should be a few words |
| | Do not cut off dialog |
| | Return up to x chapters spanning the video duration |
| | Return an array of objects with ‘title ’ (str), ‘start_time ’ |
| | (float), and ‘end_time ’ (float) |
| Examples: | *** |

In this example configuration data, the parameters include instructions such as longer video clips are preferred, not to cut-off any dialogs, prioritizing moments that show action or have dialog, titles should be a few words, etc. It will be appreciated that in other examples, these parameters may be different depending on the desired format of the output required in other implementations.

In some embodiments, the same configuration data may be used to configure the clipper 328 to generate chapters every time. In such cases, the configuration data may be predefined and stored as prompt data 128 in data storage 122. In other embodiments, the configuration data may vary (e.g., depending on requirements). In this case, the parameters of the configuration data may be updated to include any default overrides before the configuration data is added to the chapter prompt.

The server application 114 retrieves the configuration data from the data storage 122, determines whether the configuration data needs to be updated, and combines the configuration data with the audio script and key frames to generate the chapter prompt. In one embodiment, the server application 114 generates the chapter prompt by constructing a text string from one or more component parts of the configuration data, the audio script, and key frames (e.g., by concatenating the component parts together).

Once the chapter prompt is generated, the server application 114 communicates the chapter prompt to the clipper 328.

The method then proceeds to step 510, where chapters are identified. In some embodiments, this includes communicating the multi-modal prompt to the clipper 328 and receiving an output from the clipper 328 that includes the start and end timings of the different chapters and titles for the different chapters.

In particular, by way of the configuration data, the clipper 328 is cued to identify one or more chapters in the video, generate titles for the chapters, and start and end times for the chapters based, in part, on the audio script and the key frames. The output may be a string of objects that include the title as a string, start time in a numerical value and the end time in a numerical value.

The server application 114 receives the chapter output from the clipper 328 as a string of output characters, referred to as a completion.

It will be appreciated that it is presumed that the configuration data is provided to the clipper 328 each time chapters need to be generated. However, this need not be the case in all implementations. In other implementations, the configuration data may be provided to the clipper 328 each time an instance of the clipper 328 is invoked. If the same VLM instance is then used for subsequent chapter requests, the configuration data need not be submitted to the clipper 328 instance again as the clipper 328 can remember the configuration data it has been provided previously and utilize that configuration data for subsequent chapter requests. Once the clipper 328 instance is closed or exited, it may flush the configuration data and the server application 114 may need to resend the configuration data along with the script and key frames when a new instance of the clipper 328 is invoked.

Further still, it is presumed that the clipper 328 is a general purpose VLM that has not previously been trained or configured to identify chapters in the required manner. However, this need not be the case in all implementations. In some implementations, a specific purpose VLM system may be adopted that has been trained using copious amounts of training data of audio scripts and key frames and desired output chapters. In one example, the special purpose VLM system may be a combination of a visually-enabled ML such as CLIP or SigLIP (sigmoid loss for language image pre-training) and a large language model such as Mistral 7B or Llama. The visually-enabled ML generates vector embeddings for the key frames and the large language model uses these to generate titles and start and end times. There is no need to provide additional configuration data for such specifically trained clippers and in such cases, the classification prompt may simply include the audio script and key frames.

In one example, the chapters data generated by the clipper 328 at this step is shown in table C below.

TABLE C
Example chapter data for a video content item

Introduction, 4.0, 19.5
Engagement, 19.5, 28.2
Announcement, 28.2, 44.6
Challenges ahead, 46.1, 66.5
Historical context, 68.2, 90.6
Brief discussion, 94.2, 108.5

At step 512, the server application 114 receives the chapter data (including the titles and start and end timing data) from the clipper 328 and generates chapter video clips based on the chapter data. This may include, for each chapter clip, creating a chapter record that includes the corresponding chapter data. The chapter record also includes an identifier of the video content item it is associated with.

This step further includes for each chapter clip, discarding any frames from the video content item that are classified as not being part of the trimmed video clip (e.g., based on the start and end times of the chapter in the chapter data). Once the frames are discarded as described above, the remaining frames are encoded to generate each chapter clip. For each chapter clip, this may involve compressing each retained frame of the video sequence individually using a selected video codec. Compression techniques such as spatial prediction, transform coding (e.g., discrete cosine transform, DCT), quantization, and entropy coding (e.g., Huffman coding, arithmetic coding) may be applied to reduce the size of each frame while preserving visual quality. In addition to compressing individual frames, inter-frame compression techniques may be employed to exploit temporal redundancy between consecutive frames. An encoding software (e.g., FFmpeg, HandBrake, x264, x265) is then used by the output module 118 to encode the compressed frames into a video container format such as MP4, MKV, or AVI. The encoding process involves packaging the compressed frames into a container format, adding metadata (e.g., video resolution, frame rate, audio tracks), and generating an index for efficient playback.

The generated chapter clips are then communicated to the client application 132 that generated the chapter request at step 514 to render the chapter clips, e.g., in the upload region 403 of a user interface displayed on the display 218 of the client system 130.

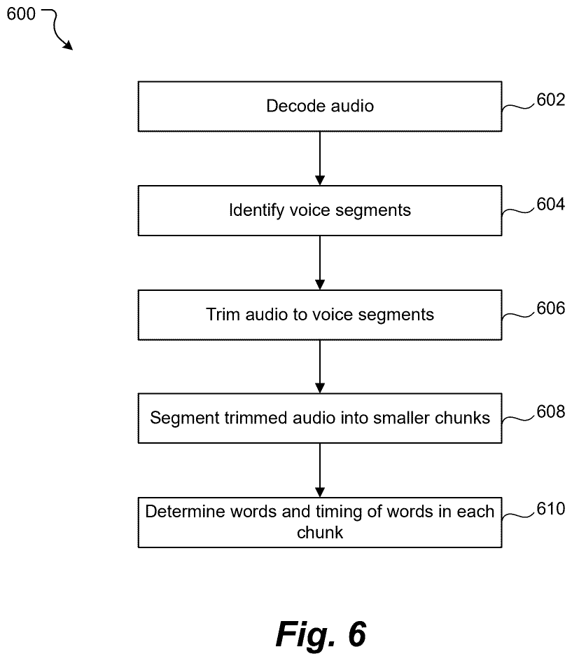

FIG. 6 illustrates an example method 600 for generating the audio transcript in method step 504. The method 600 commences at step 602, where the decoder 318 decodes an audio component of the video content item. Decoding the audio component generally includes separating the audio stream from the video stream and then converting it from its compressed format (e.g., MP3, AAC, or AC3) into a raw audio format (such as PCM). The decoder 318 may separate the audio stream from the video stream by demultiplexing the video file. Once the audio stream is extracted, the decoder 318 decodes the audio component from its compressed format. This involves reversing the encoding process that was applied during compression. Decoding reconstructs the original audio data from the compressed stream. In some embodiments, the decoder 318 may also convert the audio from one format to another at this step.

Next, at step 604, voice segments are identified in the decoded audio. This involves the activity detector 320 detecting voice activity in the decoded audio component. In some embodiments, activity detector 320 uses a voice activity detection model (VAD model). The VAD model typically starts by extracting features from the audio signal.

Feature extraction is the process of converting raw audio data into a set of representative features that can be used for subsequent analysis. This process includes pre-processing of the raw audio data, such as cleaning and formatting the data, normalizing the audio data to a standard scale, resampling the audio data in a suitable format for feature extraction, etc. Accordingly, at this step, the activity detector 320 may pre-process the audio data by, e.g., resampling, filtering, or normalizing the audio data.

Thereafter, the activity detector 320 converts the pre-processed signal into a time-frequency representation, e.g., using a Short-Time Fourier Transform (STFT). While a Discrete Fourier Transform (DFT) or Fast Fourier Transform (FFT) converts a function of time into its frequency representation (the transformation is lossless and reversible), STFT is able to represent both aspects at once. This can be imagined as cutting the signal into slices with a certain “window size” and making the slices overlap by a so-called “hop size.” For each slice, the activity detector 320 computes an FFT and concatenates the results. In some embodiments, the activity detector 320 balances the frequency and time resolution by utilizing multiple spectrograms with different window sizes as features.

Windowing captures both short-term and long-term temporal variations in the audio signals. The activity detector 320 computes features for each window, and concatenates or aggregates the results (which are computed features from each window) over time to obtain the extracted features for the entire audio signal. It will be appreciated that the activity detector 320 performs various sub-processes or mathematical operations on the data at each step. The activity detector 320 may extract various different features from the audio signal at this stage. Examples of some features include time-domain features such as root mean square (RMS energy), zero-crossing rate, and temporal spread, frequency-domain features such as spectral bandwidth, Mel-frequency cepstral coefficients (MFCCs), or rhythmic pattern descriptors, etc. These features help capture important characteristics of the audio signal that are useful for distinguishing between speech and non-speech segments.

Once the features are extracted, the activity detector 320 segments the audio signal into short frames, typically around 30 milliseconds long. Each frame is then analyzed independently. For each frame, the extracted features are fed into a machine learning model or signal processing algorithm that classifies the frame as either speech or non-speech. The model could be a neural network, a Hidden Markov Model (HMM), a Support Vector Machine (SVM), or other suitable classifier. The activity detector 320 then aggregates the classification results from individual frames over time to make a final decision about whether the audio segment as a whole contains speech or not. Various techniques such as majority voting, smoothing, or thresholding are applied to determine the presence or absence of speech activity.

Further, post-processing steps may be applied to refine the VAD decision. This could include filtering out short-duration speech segments, adjusting thresholds dynamically based on the noise level, or incorporating contextual information from neighboring frames. The effectiveness of the activity detector 320 depends on factors such as the choice of features, the design of the classification algorithm, the robustness to various types of noise and interference, and the adaptability to different acoustic environments.

In one example, the activity detector may utilize a VAD model provided by PyAnnote at this step. The VAD model by PyAnnote includes similar processing steps including feature extraction, segmentation of the audio component into frames, processing each frame to predict the likelihood of speech presence, and applying post-processing techniques to refine the final VAD decision.

The output of step 604 is a classification of the audio component into segments that are predicted to include speech and segments that are predicted to be void of speech.

At step 606, this classification is provided to the trimmer 324, which is configured to trim the audio component to the voice segments identified at step 604. The output at this step is a trimmed audio component that only includes the predicted voice segments.

Next (at step 608), the trimmed audio component is segmented into chunks of a predetermined duration. In one example, the trimmed audio component may be segmented into 30-second-long chunks.

At step 610, the chunks are communicated to the speech recognizer 322, which is trained to determine words in each chunk. Any suitable speech recognizer 322 may be utilized at this step to detect spoken words in each chunk and to generate a transcript of the trimmed audio component based on the detected words.

In one example, the speech recognizer 322 may utilize a machine learning model that incorporates an encoder-decoder transformer architecture for word detection. Layers of the transformer are designed to automatically learn relevant audio features at different levels of abstraction. Optionally, recurrent layers like Long Short-Term Memory (LSTM) or gated recurrent units (GRUs) may be incorporated to capture temporal dependencies in the audio data.

For each chunk, the speech recognizer 322 begins by extracting features from the input audio segment. The same feature extraction process may be utilized as that utilized at step 604. Examples of features extracted by the speech recognizer 322 may include MFCCs, filter banks, and Log-MEL spectrograms. These features capture characteristics of the audio signal and serve as input to the machine learning model.

The speech recognizer 322 processes the input audio chunks frame by frame. For each frame, the extracted audio features are passed through the machine learning model, which outputs a probability distribution over target words. This probability distribution represents the machine learning model's confidence in the presence of each word in the current frame. The speech recognizer 322 may then apply thresholding to the output probabilities to determine whether each frame contains a word. If the probability of a word exceeds a predefined threshold, the frame is classified as containing the word. Otherwise, the speech recognizer 322 determines that the frame does not include any words. This process is repeated for each frame.

Based on the thresholded predictions, the speech recognizer 322 detects instances where the predicted probability of the keyword exceeds the threshold for a certain duration, indicating the presence of one or more words in the audio chunk. These detected instances represent the words spoken in the audio chunk.

The speech recognizer 322 may also apply post processing techniques to smooth the word predictions over time and reduce false positives or false negatives. Techniques such as median filtering, hysteresis, or time-domain filtering may be used to refine the keyword spotting results.

In addition to detecting words in the audio chunks, the speech recognizer 322 also determines the timing of the words in each chunk at this step. In one embodiment, it is done by a timestamp prediction process implemented by the machine learning model. In this process, time is predicted relative to the audio chunk being processed. In some examples, the speech recognizer 322 may quantize all times to the nearest 20 milliseconds. Further, additional tokens are added to the vocabulary of the machine learning model for each of these quantized times. The timestamp prediction may be interleaved with the word predictions. That is, a start time token is predicted before word tokens are predicted by the machine learning model, and the end time token is predicted after the word tokens. In some examples, instead of predicting the start and end times for each word, the start and end time tokens are predicted for an entire audio chunk.

The output of step 610 is a timestamped transcript of the audio, which is generated based on concatenation of all the words and timing detected for each of the chunks in the trimmed audio component. An example of the timestamped audio transcript is provided in table A above.

In one example, the machine learning model utilized by the speech recognizer 322 is the Whisper model by OpenAI. In this model, the chunks of the audio are resampled to 16,000 Hz and an 80-channel log-magnitude Mel spectrogram representation is computed on 25 millisecond windows with a stride of 10 milliseconds. The Whisper model uses an encoder-decoder transformer. The encoder processes the input windows with a small stem including two convolution layers with a filter width of 3 and a GELU activation function where the second convolution layer has a stride of two. Sinusoidal position embeddings are then added to the output of the stem after which the encoder transformer blocks are applied. The transformer uses pre-activation residual blocks, and a final layer normalization is applied to the encoder output. The decoder uses learned position embeddings and tied input-output token representations. The encoder and decoder have the same width and number of transformer blocks.

FIG. 7 illustrates an example method 700 performed by the video analyzer 302 to identify one or more key frames of the video content item at step 506.

The method 700 commences at step 702, where the video decoder 306 decodes the video component of the video content item to extract individual frames of the video component. Decoding the video component generally includes separating the video stream from the audio stream and then converting it from its compressed format (e.g., MP4, AVI, or MKV) into a raw video format (such as PCM). The video decoder 306 may separate the video stream from the audio stream by demultiplexing the video file. Once the video stream is extracted, the video decoder 306 decodes the video component from its compressed format to reconstruct the original frames. This involves reversing the compression process that was applied during encoding.

The reconstructed frames are stored in a frame buffer or a similar data structure in memory along with frame identifiers. This buffer holds one or more frames at a time, depending on the decoding mechanism and the capabilities of the decoder. The frame identifiers may be sequential numbers that indicate the position of the frame within the video in relation to other frames in the video. For example, the frame identifier 5 indicates the fifth frame in the video and follows frame identifier 4 and is followed by frame identifier 6.

At step 704, frame embeddings are generated for each of the reconstructed frames. To this end, each of the reconstructed frames is provided to the encoder 308. Typically, a frame embedding is a vector representation of a frame in which frames with similar motifs, colors, shapes, etc., may have similar vector profiles. Generally speaking, each number in the embedding represents information of the frame and the more numbers in an embedding, the more the information about the frame encoded into the embedding. In one example, each frame embedding may include 512 numbers. In other examples, fewer or more numbers may be included in the embedding. Image encoders of pre-trained neural networks such as contrastive language-image pretraining (CLIP), residual networks (RES-Net), vision transformer (ViT) or any other ML model capable of converting frames to vector embeddings may be utilized to obtain the frame embeddings.

In any case, the encoder 308 that is utilized to analyze the frames and generate the corresponding embeddings is trained such that it can represent a sufficient amount of relevant information about the frames in the embeddings. For instance, the encoder 308 may be trained by feeding an appropriate number (hundreds of thousands if not millions) of labelled images (i.e., images and their textual description). The textual descriptions may be embedded into numerical representations using techniques such as word embeddings. The images may be pre-processed by dividing them into smaller patches or tiles. Each patch is then passed through a convolutional neural network of the embedding model to extract visual features. Both the textual embeddings and the visual features extracted from the images may be projected into a shared embedding space. The embedding model is trained using contrastive learning-embeddings of matching image-text pairs are encouraged to be closer together in the embedding space, while embeddings of non-matching pairs are pushed further apart. This encourages the model to learn embeddings that capture semantic similarities between images and their associated text.

The frames may be provided to the pre-trained encoder 308 and the encoder may generate the frame embeddings. These frame embeddings may then be stored along with the frame identifiers for further processing.

Before providing the frames to the encoder 308, the video analyzer 302 may normalize the frames to preset values. This typically depends on the type of encoder 308 utilized and the requirements of the selected encoder. For example, if a CLIP encoder is utilized, frames may first be rasterized and then resized to a preset size (e.g., 224×224).

Next (at step 706), the video analyzer 302 detects change point frames in the video based on the frame embeddings. Change point frames indicate changes in a video. In some videos, few changes may occur. For example, consider a 60 second video of a flower blowing in the wind. In this example, the content in the video is barely changing over time. In other videos, changes may occur more frequently. For example, consider a 60 second video of a basketball game. In this example, the content in the video changes very frequently over time with a lot of action taking place in a short amount of time. Accordingly, depending on the content of the video, the number of change point frames in a video may vary. In the example of the flower video, 2-3 change point frames may be detected, whereas in the example of the basketball game, 20-30 change point frames may be detected.

In order to detect the change point frames, the vector embedding of each frame is analyzed. In particular, a change in the vector embeddings over time is analyzed. If the vector embeddings change by a threshold amount between frames, a change point is detected. Alternatively, if the vector embeddings change by less than a threshold amount between frames, the frames are considered relatively similar, and no change point is detected.

The algorithm for detecting change includes performing pairwise comparisons between the embeddings of consecutive frames. To perform the pairwise comparisons, the vector embeddings of consecutive frames are first arranged in a matrix format, where each row corresponds to the embedding of a single frame. This results in a feature matrix where the rows represent frames, and the columns represent the dimensions of the embedding space.

A kernel matrix is then computed by taking the inner product (dot product) between each pair of rows in the feature matrix. This operation calculates the similarity or dissimilarity between pairs of frames based on their embeddings. Mathematically, the kernel matrix K is computed as Kij=φ(embeddingᵢ)·℠(embeddingⱼ), Where φ is a feature mapping function that maps the embeddings to a higher-dimensional space where the inner product can be efficiently computed. The kernel matrix serves as the basis for similarity measurement techniques. Metrics like Euclidean distance, cosine similarity, or other similarity measures can be used for this purpose.

Next, a cost matrix can be constructed using the kernel matrix, where each element represents the cost of transitioning from one frame to another. Lower costs indicate higher similarity between frames, while higher costs indicate greater dissimilarity. This cost matrix forms the basis for dynamic programming. Dynamic programming techniques, such as the Viterbi algorithm or the Bellman-Ford algorithm, can then be applied to find the optimal sequence of change points in the video. The algorithm recursively evaluates possible change point sequences and selects the sequence with the minimum total cost. The dynamic programming algorithm may incorporate non-linear optimization techniques to handle cases where the cost function is non-linear or where additional constraints need to be enforced. This optimization step ensures that the detected change points accurately capture the significant transitions in the video. Once the optimal sequence of change points is determined, these points are considered as the locations where significant changes occur in the video content.

In one embodiment, the change points are identified based on the frame identifiers of the frames where the changes were detected. The output of this step is a set of frame identifiers corresponding to the change points.

The method 700 then proceeds to step 708, where the video frames are provided to the shot detector 310, which identifies shots in the video content item. A shot is a continuous sequence of frames taken by a particular camera. Edited videos are generally composed of multiple shots taken from the same camera (at different positions) or from different cameras that are stitched together. Identifying shots in the video helps the video analyzer 302 to understand how the video changes in the subsequently generated video script. It also allows the video analyzer 302 to caption shots independently.

The shot detector 310 may utilize a suitable shot detection technique. In one example, the shot detector 310 may be based on the PySceneDetect process. In this example, the shot detector 310 utilizes one of several different scene detection methods to analyze video frames and identify scene changes. These methods include a threshold-based method that analyses differences in pixel intensity between adjacent frames. If the difference in pixel intensity exceeds a certain threshold, a scene change is detected. Another method is a content-based method that uses more advanced techniques, such as clustering or feature extraction, to analyze the content of frames and detect scene changes based on visual similarity. The shot detector 310 processes the video frames sequentially, comparing each frame to its adjacent frames to detect changes. For each frame, the shot detector 310 computes a metric or feature that indicates the degree of difference or similarity between frames. Based on the selected scene detection method, the shot detector 310 analyses these metrics and determines if a scene change has occurred. When a scene change is detected, the shot detector 310 records the timestamp or frame number of the change. Once scene changes are detected, the shot detector 310 generates an output file or data structure including information about the detected scenes. This output typically includes the timestamps or frame numbers of the scene changes.

In another embodiment, the shot detector 310 may first generate an RGB tensor for each frame in the video content item and load the RGB tensors onto a graphical processing unit. An RGB tensor is a multi-dimensional array that represents a frame in the RGB (Red, Green, Blue) color space. Each element of the tensor corresponds to the intensity of a specific color channel (red, green, or blue) at a particular pixel in the frame. In a typical RGB tensor, the first dimension usually represents the height of the frame (number of rows), the second dimension typically represents the width of the frame (number of columns), and the third dimension represents the color channels, with three channels for red, green, and blue, respectively. For example, a 3D RGB tensor with shape (height, width, 3) might represent a color frame with height rows, width columns, and three color channels. The values in the tensor usually range from 0 to 255, representing the intensity of each color channel. A value of 0 indicates no intensity (black), while a value of 255 indicates full intensity (saturated color).

Each RGB tensor may then be converted into floating-point. Converting an RGB tensor to floating point involves normalizing the pixel values from their original range (e.g., between 0 and 255) to a floating-point range (typically between 0.0 and 1.0 or −1.0 and 1.0).

The floating point RGB tensors are also copied and converted into HSV tensors. Converting an RGB tensor to an HSV (Hue, Saturation, Value) tensor typically involves a transformation from RGB to HSV. This transformation allows for better separation of color information, making it easier to analyze and manipulate certain aspects of the image, such as hue and saturation.

To convert the floating point RGB to HSV, a conversion formula is applied to each floating-point value to transform each pixel value from RGB to HSV. The conversion involves calculating the hue, saturation, and value components of each pixel in the image. Hue can be computed by calculating an arctangent function applied to the ratio of green-blue and red-green differences. Saturation can be calculated as the ratio of the difference between the maximum and minimum RGB values to the maximum value and the value component (which represents the brightness of the color) can be calculated using a suitable conversion formula.

Once the RGB and HSV tensors are generated, the RGB and HSV tensors for consecutive frames are retrieved and the differences between the RGB and HSV tensors for these consecutive frames are computed. The difference is computed as a mean or single scalar value for each pair of consecutive frames.

In one embodiment, the shot detector then suppresses or discards any difference HSV values that are below a certain threshold value. This suppression highlights the frames that have high HSV difference values (indicating consecutive frames that have rapid changes in color). These highlighted frames are further filtered based on the RGB difference values. For example, the RGB difference values for the highlighted frames are inspected. If the RGB difference values are below a threshold value (e.g., 0), these highlighted frames are also discarded. However, if the RGB difference values are above a threshold value (e.g., greater than 0), the corresponding highlighted frames are retained.

In another embodiment, the shot detector 310 first suppresses or discards any difference RGB values that are below a certain threshold value and then further filter these based on HSV difference values.

Each of the retained pairs of consecutive frames are considered shot change frames. The shot detector 310 records the timestamp or frame number of each of these shot change frames. For example, if two shot changes involve frame identifiers 6 and 7 and 18 and 19, the shot detector 310 records the frame numbers 7 and 19.

The shot detector 310 then generates an output file or data structure containing information about the detected shots. This output typically includes the timestamps or frame numbers of the shot changes.

Once shot frames and change frames are detected (at steps 708 and 706, respectively), the method proceeds to step 710, where the aggregator 314 combines the shot frames and change point frames. This involves the aggregator 314 generating a combined output file or data structure that includes the frame identifiers of the frames that corresponding to each detected shot and the frame identifiers of the frames that correspond to each detected change point. In another example, the aggregator may generate different files for each shot, where each file includes the frame identifiers of the change points that are included in the corresponding shot. For example, if a shot is between frame identifiers 1 and 20 and the change point file includes frame identifiers 5, 13, and 18, the shot file for that shot includes all the change point identifiers that fall within the shot frame identifiers (that is, the frame identifiers 5, 13 and 18 in this example).

The method 700 then ends.

### Alternate Embodiment

In the method described above, chapters are identified by a VLM based on the audio transcript and the aggregated frames of step 810. In other embodiments, the chapters may be identified by an LLM that is not visually enabled. In such cases, the video analyzer 302 also includes a captioning system (not shown) that is configured to generate a caption for each frame in the aggregated set of shots and their corresponding change point frames.

In this embodiment, at step 506 captions are generated for the key frames. In particular, the single or multiple combined output file(s) are utilized to retrieve embeddings of the video frames that correspond to the frame identifiers in the file(s). These retrieved video frame embeddings are provided to the captioning system, which generates the captions based on these retrieved embeddings. In one embodiment, the change point frame embeddings for each shot are provided sequentially to the captioning system, such that each shot is captioned one at a time. In another example, all the retrieved frame embeddings are provided to the captioning system at once so that it generated captions for the various shots in parallel or at once.

In some embodiments, the captioning system utilizes a vision-capable machine learning model to generate the captions. In such cases, the captioning system first generates a caption prompt, which is subsequently provided to the machine learning model.

The content of the caption prompt depends on the type of machine learning model being used. If the machine learning model is a general-purpose vision enabled LLM, the caption prompt includes the embeddings of the video frames and configuration data. The configuration data provides instructions to the machine learning model to generate the captions.

In case the machine learning model is a specific ML model that has already been trained for the specific task of generating captions for input video frames, the caption prompt may only include the embeddings of the video frames without any configuration data.

The precise format of the configuration data depends on a variety of factors, including the type of LLM, the training mechanism of the machine learning model, and the content of the input data.

In one example, the configuration data for the caption prompt may include a brief description of the task (e.g., to generate captions for the video frames), parameters for the task (e.g., output format, type of captions, rules, etc.), and one or more training examples of video frames and the captions the machine learning model is expected to generate based on those examples of video frames. Table D below shows examples of configuration data that can be used in the embodiment where shots are captioned one at a time.

TABLE D
example configuration data for a captions prompt

| | |
|---|---|
| Description | Provide captions for the following frames of a single |
| of task: | video shot. Some frames have screen recordings, |
| | animations, or blank screens. |
| Parameters: | Caption format *** |
| | Summary: SUMMARY |
| | Frames |
| | TIME: CAPTION*** |
| | One caption per frame |
| | Be brief, terse, and accurately describe what is |
| | happening visually. |
| | Describe the motion of the camera, keep things |
| | temporally consistent. |
| | Video frames are selected when content changes. |
| | Assume the content between frames is similar. |
| Examples: | Summary: a man plays basketball in front of his house, |
| | shoots, and misses |
| | Frames |
| | 0.0: A young man in red shorts plays basketball outside |
| | a white house. The sun reflects off the ground near |
| | his feet. |
| | 4.0: He faces the hoop. Basketball resting between his |
| | hand and side. |
| | 8.0: He runs towards the hoop with the basketball |
| | 10.2: He shoots. He is airborne, the basketball is mid- |
| | flight. |
| | 14.0: The ball bounces off the right edge of the ring |
| | 15.3: The looks at the ground, appearing sad, shoulders |
| | slumped |
| | 20.0: The basketball rolls back to his feet |

It will be appreciated that instead of the three components displayed in the table above, the configuration data may include many alternative components, and that many alternative approaches to generating a caption prompt are possible. For example, the configuration data may be (or include) a single pre-assembled prompt—e.g. a string that includes the relevant components. Alternatively, separate prompts may be generated including separate components and combinations thereof. The machine learning model can thus be configured by providing the configuration data as a prompt, part of a prompt, or series of prompts.

In some embodiments, the same configuration data may be used to configure the machine learning model to generate the captions every time. In such cases, the configuration data may be predefined and stored in the prompt data 128 in the data storage 122.

The captioning system retrieves the configuration data from the data storage 122 and combines the configuration data with the embeddings of the retrieved video frames (e.g., the frames related to the shot being captioned if the shots are captioned one at a time or all the retrieved frames if the shots are captioned together) to generate the caption prompt. In one embodiment, the captioning system generates the caption prompt by constructing a text string from one or more component parts of the configuration data and the embeddings of the video frames.

Once the caption prompt is generated, the captioning system communicates the caption prompt to the machine learning model.

By way of the configuration data, the machine learning model is cued to generate the captions, in part, on the embeddings of the video frames. The captions may be a string of text, including a summary of the shot and the times and captions for each frame in the shot.

The captions describe the images or scenes in the one or more frames. In one example, the captions may be a string of characters, e.g., 1-2 sentences that capture the essence of the scene and any action taking place in the scene. An example of the captions generated at this step for a cooking video are provided in table E below—

TABLE E
Example captions for a video content item

0.0→50: A chef stands in a kitchen, then the scene shifts to a close-up of
a hand interacting with food items on a table.
4.0: A chef in a white uniform stands in a kitchen with stainless steel
appliances.
20.0: The chef remains in the same position, with a slight change in facial
expression.
22.0: the chef begins to speak, with a subtitle appearing at the bottom of
the screen.
32.0: the scene changes to a close-up of a hand holding a bowl of
spaghetti.
36.0: the camera focuses on a bowl of spaghetti on a table.
38.0: the hand picks up a small amount of spaghetti.
42.0: the hand holds the spaghetti above the bowl.
44.0: the camera pans to show a bowl of green vegetables on the table.
48.0: caption: A hand holds a bottle of olive oil over a kitchen counter
with ingredients nearby.

Once the captions are generated, instead of generating a chapter prompt, a timestamped script of the video content item is generated based on the transcript and the captions. In one embodiment, a script generation system (not shown) generates the script by combining the audio transcript and the captions. The script includes an overall caption for the video content item along with the start and end timing of the video content item, one or more dialogs and one or more captions. The video script also distinguishes between dialogs and captions. In one example, this may be done by annotating the spoken words in the audio transcript with the word “dialog” and annotating the captions with the word “caption.” The dialogs are further annotated with the time (in seconds) when they were spoken in the video content item, whereas the captions are annotated with the frame identifier or time corresponding to the frame the captions are related to.

An example of a timestamped script for a video related to cooking is shown in table F below.

TABLE F
example video script for a video content item

0.0->50: shot: 1. A chef stands in a kitchen, then the scene shifts to a
close-up of a hand interacting with food items on a table.
2.7->4.0: dialog: Hello,
4.0: caption: A chef in a white uniform stands in a kitchen with stainless
steel appliances.
4.0->8.6: dialog: my name is ABC and I'm inside the kitchen XYZ Pizza
8.6->ll.2: dialog: restaurant in Malaysia.
11.2->13.5: dialog: We have a few outlets open,
13.5->15.1: dialog: XYZ Pizza.
15.1->15.1: dialog: And,
15.1->19.5: dialog: honor by ABC's family.
19.5->19.7: dialog: So,
19.7->23.6: dialog: today I'm going to show you spaghetti,
20.0: caption: The chef remains in the same position, with a slight change
in facial expression.
22.0: caption: The chef begins to speak, with a subtitle appearing at the
bottom of the screen.
23.6->26.0: dialog: aglio e ollo and chili.
26.0->26.8: dialog: Spaghetti,
26.8->28.2: dialog: aglio e olio and pepperoncino.
28.2->31.9: dialog: The most important thing you need
32.0: caption: The scene changes to a close-up of a hand holding a bowl
of spaghetti.
34.3->35.8: dialog: Like you see,
35.8->38.4: dialog: very good pasta.
36.0: caption: The camera focuses on a bowl of spaghetti on a table.
38.0: caption: The hand points to the spaghetti bowl.
38.4->40.4: dialog: Garlic,
40.0: caption: The hand picks up a small amount of spaghetti.
40.4->41.8: dialog: chili.
41.8->44.6: dialog: You can use chili flakes or red chili.
42.0: caption: The hand holds the spaghetti above the bowl.
44.0: caption: The camera pans to show a bowl of green vegetables on
the table.
44.6->45.9: dialog: Italian parsley,
46.0: caption: The camera focuses on a bowl of green vegetables, with a
bowl of spaghetti in the foreground.
45.9->47.6: dialog: salt.
47.6->50.7: dialog: And olive oil.
48.0: caption: A hand holds a bottle of olive oil over a kitchen counter
with ingredients nearby.

The timestamped script is then provided to an LLM that is configured to identify chapters in the video based on the video script.

In the above embodiments certain operations are described as being performed by the client system 130 (e.g. under control of the client application 132) and other operations are described as being performed at the video editing server 110. Variations are, however, possible. For example, in certain cases an operation described as being performed by client system 130 may be performed at the video editing server 110 and, similarly, an operation described as being performed at the video editing server 110 may be performed by the client system 130. Generally speaking, however, where user input is required such user input is initially received at client system 130 (by an input device thereof). Data representing that user input may be processed by one or more applications running on client system 130 or may be communicated to video editing server 110 for one or more applications running on the server hardware 112 to process. Similarly, data or information that is to be output by a client system 130 (e.g. via display, speaker, or other output device) will ultimately involve that system 130. The data/information that is output may, however, be generated (or based on data generated) by client application 132 and/or the video editing server 110 (and communicated to the client system 130 to be output).

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by (or in conjunction with) different applications running on the same or different computer processing systems.

In the above description, certain operations and features are explicitly described as being optional. This should not be interpreted as indicating that if an operation or feature is not explicitly described as being optional it should be considered essential. Even if an operation or feature is not explicitly described as being optional it may still be optional.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

Unless otherwise stated, the terms “include” and “comprise” (and variations thereof such as “including,” “includes,” “comprising”, “comprises”, “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer implemented method for generating a set of chapter clips for a video content item, the method comprising:
receiving a request to generate the set of chapter clips, the request including the video content item;
generating an audio transcript from an audio component of the video content item;
generating one or more key frames from a video component of the video content item;
identifying a set of chapters in the video content item based on the audio transcript and the one or more frames, each chapter comprising a start time and an end time;
generating the set of chapter clips based on the identified set of chapters based on the start time and the end time of each chapter; and
causing display of the set of chapter clips in a user interface displayed on a user device.

2. The method of claim 1, wherein identifying the set of chapters in the video content item comprises:
generating a chapter prompt including the audio transcript, the one or more frames and configuration data to identify the one or more chapters; and
communicating the chapter prompt to a vision-enabled language model that is configured to identify the one or more chapters based on the chapter prompt.

3. The method of claim 1, wherein identifying the one or more key frames comprises:
decoding the video content item to extract a set of frames from the video content item;
generating embeddings for each frame in the set of frames; and
detecting one or more change point frames in the set of frames based on the embeddings.

4. The method of claim 3, wherein detecting the one or more change point frames comprises:
performing a pairwise comparison between the embeddings of consecutive frames in the set of frames;
determining a dissimilarity value for each pairwise comparison, the dissimilarity value indicating a level of change between the consecutive frames in each pair;
determining whether the dissimilarity value of any of the pairs of frames exceeds a threshold dissimilarity value; and
upon determining that the dissimilarity value of at least one pair of frames exceeds a threshold dissimilarity value, identifying a frame from the at least one pair of frames as a change point frame.

5. The method of claim 3, further comprising identifying one or more shot frames in the video content item based on the embeddings of the set of frames.

6. The method of claim 5, wherein identifying the one or more shot frames in the video content item comprises:
determining differences in pixel intensity between adjacent frames in the set of frames;
determining whether the difference in pixel intensity between adjacent frames exceeds a threshold value; and
upon determining that the difference in pixel intensity between at least one pair of adjacent frames exceeds the threshold value, identifying a frame from the at least one pair of adjacent frames as a shot frame.

7. The method of claim 5, wherein identifying the one or more shot frames in the video content item comprises:
generating RGB tensors for each frame in the set of frames;
converting the RGB tensors into floating point;
generating HSV tensors for each frame in the set of frames based on the converted RGB tensors;
computing differences between corresponding RGB tensors and corresponding HSV tensors for pairs of consecutive frames;
identifying one or more pairs of consecutive frames that have differences in corresponding HSV tensors exceeding a threshold value and a non-zero difference in the corresponding RGB tensors; and
identifying a frame of each of the one or more pairs of consecutive frames as shot frames.

8. The method of claim 5, further comprising combining the shot frames and change detection frames to generate the one or more key frames.

9. The method of claim 8, further comprising generating captions for the one or more key frames.

10. The method of claim 9, wherein generating the captions for the one or more key frames comprises:
generating a caption prompt, the caption prompt including identifiers of the shot frames and change detection frames, the embeddings the shot frames, and the embeddings of the change detection frames, wherein generating the caption prompt includes adding configuration data, the configuration data including a task description to generate captions for the shot frames and change detection frames, and parameters for generating the captions; and
communicating the caption prompt to a large language machine learning model, the large language model configured to generate captions for each of the shot frames and change detection frames based on the embeddings of the shot frames, the embeddings of the change detection frames, and the configuration data.

11. The method of claim 1, wherein generating the audio transcript comprises:
identifying voice segments in the audio component of the video content item;
trimming the audio component to the identified voice segments;
segmenting the trimmed audio component into chunks of a predetermined size;
predicting one or more words in each chunk;
predicting a start and end timing of the one or more words in each chunk; and
aggregating the predicted one or more words in each chunk and the predicted start and end timing of the one or more words in each chunk.

12. A computer processing system including:
a processing unit; and
a non-transitory computer-readable storage medium storing instructions, which when executed by the processing unit, cause the processing unit to:
receive a request to generate the set of chapter clips, the request including the video content item;
generate an audio transcript from an audio component of the video content item;
generate one or more key frames from a video component of the video content item;
identify a set of chapters in the video content item based on the audio transcript and the one or more frames, each chapter comprising a start time and an end time;
generate the set of chapter clips based on the identified set of chapters based on the start time and the end time of each chapter; and
cause display of the set of chapter clips in a user interface displayed on a user device.

13. The computer processing system of claim 12, wherein identifying the set of chapters in the video content item comprises:
generating a chapter prompt including the audio transcript, the one or more frames and configuration data to identify the one or more chapters; and
communicating the chapter prompt to a vision-enabled language model that is configured to identify the one or more chapters based on the chapter prompt.

14. The computer processing system of claim 12, wherein identifying the one or more key frames comprises:
decoding the video content item to extract a set of frames from the video content item;
generating embeddings for each frame in the set of frames; and
detecting one or more change point frames in the set of frames based on the embeddings.

15. The computer processing system of claim 14, wherein detecting the one or more change point frames comprises:
performing a pairwise comparison between the embeddings of consecutive frames in the set of frames;
determining a dissimilarity value for each pairwise comparison, the dissimilarity value indicating a level of change between the consecutive frames in each pair;
determining whether the dissimilarity value of any of the pairs of frames exceeds a threshold dissimilarity value; and
upon determining that the dissimilarity value of at least one pair of frames exceeds a threshold dissimilarity value, identifying a frame from the at least one pair of frames as a change point frame.

16. The computer processing system of claim 14, further comprising instructions, which when executed by the processing unit, cause the processing unit to identify one or more shot frames in the video content item based on the embeddings of the set of frames by:
determining differences in pixel intensity between adjacent frames in the set of frames;
determining whether the difference in pixel intensity between adjacent frames exceeds a threshold value; and
upon determining that the difference in pixel intensity between at least one pair of adjacent frames exceeds the threshold value, identifying a frame from the at least one pair of adjacent frames as a shot frame.

17. The computer processing system of claim 14, further comprising instructions, which when executed by the processing unit, cause the processing unit to identify one or more shot frames in the video content item based on the embeddings of the set of frames by:
generating RGB tensors for each frame in the set of frames;
converting the RGB tensors into floating point;
generating HSV tensors for each frame in the set of frames based on the converted RGB tensors;
computing differences between corresponding RGB tensors and corresponding HSV tensors for pairs of consecutive frames;
identifying one or more pairs of consecutive frames that have differences in corresponding HSV tensors exceeding a threshold value and a non-zero difference in the corresponding RGB tensors; and
identifying a frame of each of the one or more pairs of consecutive frames as shot frames.

18. The computer processing system of claim 14, further comprising instructions, which when executed by the processing unit, cause the processing unit to combine the shot frames and change detection frames to generate the one or more key frames.

19. The computer processing system of claim 14, further comprising instructions, which when executed by the processing unit, cause the processing unit to generate captions for the one or more key frames by:
generating a caption prompt, the caption prompt including identifiers of the shot frames and change detection frames, the embeddings the shot frames, and the embeddings of the change detection frames, wherein generating the caption prompt includes adding configuration data, the configuration data including a task description to generate captions for the shot frames and change detection frames, and parameters for generating the captions; and
communicating the caption prompt to a large language machine learning model, the large language model configured to generate captions for each of the shot frames and change detection frames based on the embeddings of the shot frames, the embeddings of the change detection frames, and the configuration data.

20. A non-transitory storage medium storing instructions executable by processing unit to cause the processing unit to:
receive a request to generate the set of chapter clips, the request including the video content item;
generate an audio transcript from an audio component of the video content item;
generate one or more key frames from a video component of the video content item;
identify a set of chapters in the video content item based on the audio transcript and the one or more frames, each chapter comprising a start time and an end time;
generate the set of chapter clips based on the identified set of chapters based on the start time and the end time of each chapter; and
cause display of the set of chapter clips in a user interface displayed on a user device.
